(19) United States
(12) Patent Application Publication
(10) Pub. No.: US 2026/0086475 A1
(43) Pub. Date: Mar. 26, 2026

(54) IMAGE FORMING APPARATUS, METHOD OF CONTROLLING IMAGE FORMING APPARATUS, AND STORAGE MEDIUM

(71) Applicant: CANON KABUSHIKI KAISHA, Tokyo (JP)

(72) Inventor: TORU SAKAGUCHI, Kanagawa (JP)

(21) Appl. No.: 19/332,277

(22) Filed: Sep. 18, 2025

(30) Foreign Application Priority Data
Sep. 26, 2024 (JP) 2024-167604

(51) Int. Cl. G03G 15/08; G03G 21/18

(52) U.S. Cl. CPC G03G 15/0881; G03G 21/1875; G03G 2221/1892

(57) ABSTRACT

An image forming apparatus on which an initial state cartridge, which is a cartridge with a seal member attached, is installable includes a removal unit configured to perform an operation of removing one or more seal members of one or more initial state cartridges installed, and a notification unit configured to, in a case where the removal unit fails to remove the one or more seal members, make a notification of information that at least one of the installed initial state cartridges is to be uninstalled from the image forming apparatus.

### BACKGROUND

### Field of the Technology

The present disclosure relates to an image forming apparatus, a method of controlling an image forming apparatus, and a storage medium.

### Description of the Related Art

In some consumables such as toner cartridges for use in image forming apparatuses, a seal is attached to cover an opening in an initial state for the purposes of preventing a toner or the like contained therein from leaking and protecting the toner or the like. In order to use a cartridge in such an initial state in an image forming apparatus, the seal member has to be removed from the opening of the cartridge before printing is performed.

Japanese Patent Laid-Open No. 2003-150021 describes a technique for, upon installation of a cartridge in an initial state, automatically winding up and removing a seal member attached to an opening of the cartridge. This saves a user from having to remove the seal member.

### SUMMARY

There is a demand for an improvement of usability in a setting of cartridges in an image forming apparatus.

Therefore, the present disclosure has an object to improve usability in a setting of cartridges in an image forming apparatus.

According to an aspect of the present disclosure, an image forming apparatus is an image forming apparatus on which an initial state cartridge, which is a cartridge with a seal member attached, is installable and includes a removal unit configured to perform an operation of removing one or more seal members of one or more initial state cartridges installed, and a notification unit configured to, in a case where the removal unit fails to remove the one or more seal members, make a notification of information that at least one of the installed initial state cartridges is to be uninstalled from the image forming apparatus.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an example of a system configuration.

FIG. 2 is a diagram illustrating an example of a hardware configuration of an image forming apparatus.

FIG. 3 is a diagram illustrating an example of a software configuration of the image forming apparatus.

FIG. 4 is a diagram illustrating an example of a hardware configuration of a mobile terminal.

FIG. 5 is a diagram illustrating an example of a software configuration of the mobile terminal.

FIG. 6 is a diagram illustrating an example of a display/operation unit of the image forming apparatus.

FIG. 7 is a processing operation flow presenting a procedure for recovering from a seal removal error.

FIG. 8 is a diagram illustrating an example of a seal removal error screen.

FIG. 9 is a diagram illustrating an example of a seal removal error screen.

FIG. 10 is a diagram illustrating an example of a cartridge non-installation error screen.

FIG. 11 is a diagram illustrating an example of a seal removal error screen.

FIG. 12 is a diagram illustrating an example of a seal removal error screen.

### DESCRIPTION OF THE EMBODIMENTS

Hereinafter, a best mode for carrying out the present disclosure will be described with reference to the attached drawings. The following embodiments are not intended to limit the disclosure according to claims. In addition, all the combined features described in the embodiments are not necessarily essential for the solution of the disclosure. The following embodiments will be described by using an image forming apparatus as an example of an information processing apparatus, but the information processing apparatus is not limited to this.

### Embodiment 1

First, an outline of Embodiment 1 will be described. As described above, there is the technique for, upon installation of a cartridge in an initial state, automatically winding up and removing the seal member attached to the opening of the cartridge. In the case where the seal removal fails, a user takes out the cartridge in the initial state from a device, shakes the cartridge to loosen toner clumps inside the cartridge, dissolve the adhesion of the toner to the seal, and then reinstalls the cartridge in the image forming apparatus, so that the seal can be removed successfully. However, in a cartridge with a high toner packing, such as a large-capacity cartridge, there are often cases where the toner clumps inside cannot be loosened even though the cartridge is shaken. In the case of a large-capacity cartridge in an initial state, even though the cartridge is shaken and then installed in an image forming apparatus, the seal may not be removed successfully. In such a case, it is necessary to reduce the number of cartridges in the initial state in a seal removal operation, thereby reducing a torque required and avoiding a torque shortage to enable the seals to be removed successfully. However, there is a problem in that a user does not know a proper procedure to achieve this. Therefore, in the present embodiment, description will be given of a method of successfully removing seal members by presenting, to a user, a procedure for an appropriate handling method in the case where the removal of the seal members fails.

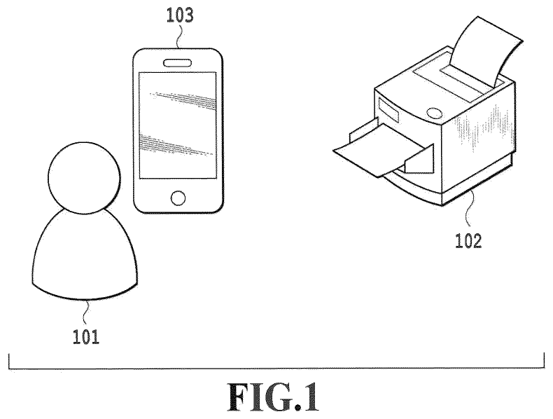

FIG. 1 is a diagram illustrating an environment for carrying out the present embodiment. A user 101 is a user who uses an image forming apparatus 102 and a mobile terminal 103. The user 101 can carry out various things such as copying, printing, and scanning by using the image forming apparatus 102. The user 101 can make settings and instructions for devices by operating the mobile terminal 103 or a display/operation unit 207 of the image forming apparatus 102.

In the present embodiment, the image forming apparatus 102 is described by using a multifunction peripheral (MFP) as an example, but may be another type of image forming apparatus such as a printer. In the present embodiment, the system configuration using the mobile terminal 103 is described as an example, but a system configuration not using the mobile terminal 103 may be used.

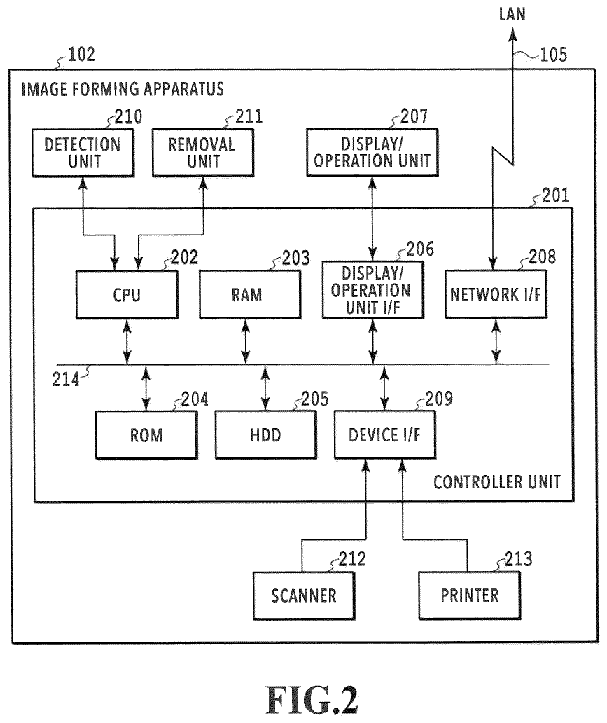

FIG. 2 is a hardware configuration diagram of the image forming apparatus 102. The image forming apparatus 102 includes a controller unit 201, the display/operation unit 207, a detection unit 210, and a removal unit 211. The controller unit 201 includes a CPU 202, a RAM 203, a ROM 204, a hard disk drive (HDD) 205, a display/operation unit I/F 206, a network I/F 208, and a device I/F 209.

In the controller unit 201 in the image forming apparatus 102, the CPU 202 is a calculation apparatus to control the entire system. The CPU 202 controls devices connected to a system bus 214.

The RAM 203 is a volatile memory and is used as temporary storage areas such as a main memory and a work area for the CPU 202. In the RAM 203, programs such as an operation system, system software, and application software and data are located. The ROM 204 is a non-volatile memory and stores image data, other types of data, and various programs for causing the CPU 202 to operate.

The CPU 202 controls the units in the image forming apparatus 102 by loading a program stored in the ROM 204 or the like to the RAM 203 and executing the program. The program for causing the CPU 202 to operate is not limited to the program stored in the ROM 204, but may be a program stored in advance in the HDD 205 or the like. The HDD 205 stores the operating system, system software, application software, image data, setting data, and so on. Instead of the HDD 205, any other type of storage apparatus such as an SSD, an SD memory card, or an eMMC may be used as long as it can store data.

The display/operation unit I/F 206 is an interface with the display/operation unit 207 and outputs information to be displayed on the display/operation unit 207 to the display/operation unit 207. The display/operation unit I/F 206 also receives information input by the user 101 from the display/operation unit 207. The display/operation unit 207 includes hard keys 601 to 605 for receiving user's operations. The hard keys 601 to 605 are physically depressible keys such as numeric keys, a start key, or a stop key, and each make a notification to the display/operation unit I/F 206 in the case where the key is pressed. The display/operation unit 207 includes a display 606 for displaying an image. The display 606 receives a graphical user interface (GUI) screen generated by the CPU 202 from the display/operation unit I/F 206 and displays the GUI screen.

The network I/F 208 is connected to a network (LAN) to communicate with apparatuses connected to the same LAN and to input and output information from and to the apparatuses. The device I/F 209 connects the controller unit 201 with image input/output devices, namely, a scanner 212 and a printer 213, and inputs and outputs image data. Specifically, for example, the device I/F 209 enables operations such as printing image data on a sheet and scanning a document.

The detection unit 210 plays a role in detecting that a cartridge is installed in the image forming apparatus 102. Regarding a detection method, the detection unit 210 may include, but not limited to, for example, a sensor configured to be pressed with installation of a cartridge or a sensor configured to detect a cartridge. The cartridge is a so-called process cartridge installable in the image forming apparatus 102 and stores a toner or the like to be used for image formation. In the present embodiment, the cartridges are of four types: yellow, magenta, cyan, and black. Moreover, a cartridge in which a seal member (hereinafter also simply referred to as a seal) is attached to seal an opening for the purposes of preventing a toner or the like contained therein from leaking and protecting the toner or the like will be referred to as an initial state cartridge. The detection unit 210 also determines whether an installed cartridge is an initial state cartridge.

The removal unit 211 plays a role in removing the seal member of an initial state cartridge. The removal unit 211 has a function of winding up and removing the seals attached to the openings of initial state cartridges with a rotation shaft in the case where the detection unit 210 detects the installation of the initial state cartridges. In the present embodiment, the removal unit 211 automatically and simultaneously removes the seals from all the initial state cartridges installed in the image forming apparatus 102. That is, all the seals attached to the initial state cartridges are removed in a single removal operation. The present embodiment will be described by using an example in which all the seals are removed by using the torque of the same rotation shaft, but seal removal means may be any other means.

The printer 213 is a unit to print an image on a sheet by using one or more cartridges based on raster image data received from the controller unit 201.

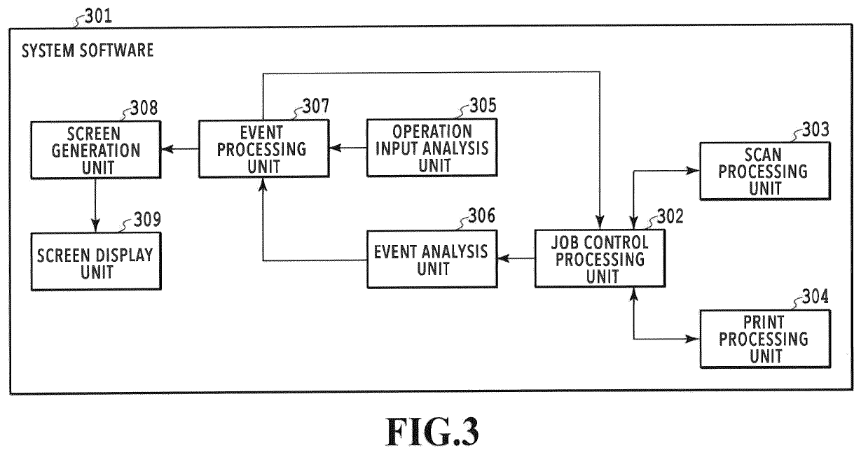

FIG. 3 is a software configuration diagram of the image forming apparatus 102. System software 301 is stored in any storage unit among the RAM 203, the ROM 204, and the HDD 205, and is executed by the CPU 202. In the present embodiment, the system software 301 includes a job control processing unit 302, a scan processing unit 303, a print processing unit 304, an operation input analysis unit 305, an event analysis unit 306, an event processing unit 307, a screen generation unit 308, and a screen display unit 309.

The job control processing unit 302 controls various software modules including a not-illustrated software modules, and controls jobs such as copying, printing, and scanning executed by the image forming apparatus 102. The scan processing unit 303 controls the scanner 212 via the device I/F 209 based on an instruction from the job control processing unit 302, and reads a document placed on a platen glass of the scanner 212.

The print processing unit 304 controls the printer 213 via the device I/F 209 based on an instruction from the job control processing unit 302, and performs print processing of a designated image. The operation input analysis unit 305 analyzes information provided from the display/operation unit 207 via the display/operation unit I/F 206 and notifies the event processing unit 307 of an event depending on a user's operation. The information analyzed in the operation input analysis unit 305 is operation information indicating that the user presses any of the hard keys.

The event analysis unit 306 receives various incidents, occurring in the image forming apparatus 102, other than operation inputs from the job control processing unit 302 and the like, analyzes each of the incidents, and notifies the event processing unit 307 of an event depending on the incident. The various incidents analyzed by the event analysis unit 306 are incidents other than incidents occurring in response to operations by the user 101, such as the completion of a job and a shortage of print sheets. The event processing unit 307 receives an event from the operation input analysis unit 305, the event analysis unit 306, or the like. Depending on the event, the event processing unit 307 notifies the job control processing unit 302, the screen generation unit 308, or a software keyboard control unit 310 of the event, and controls the units in the image forming apparatus 102.

The screen generation unit 308 performs processing in which screen data to be displayed on the display/operation unit 207 or a display unit of an external apparatus is generated on the RAM 203. In response to an operation by the user 101, a change in the status, or the like, the screen generation unit 308 updates the screen data to be displayed on the display/operation unit 207 or the like. The screen display is updated with the display/operation unit 207 or the like displaying the updated screen data via the screen display unit 309. The screen display unit 309 reads the screen data generated by the screen generation unit 308 from the RAM 203, and performs display control to display the screen data on a display of the display/operation unit 207 via the display/operation unit I/F 206.

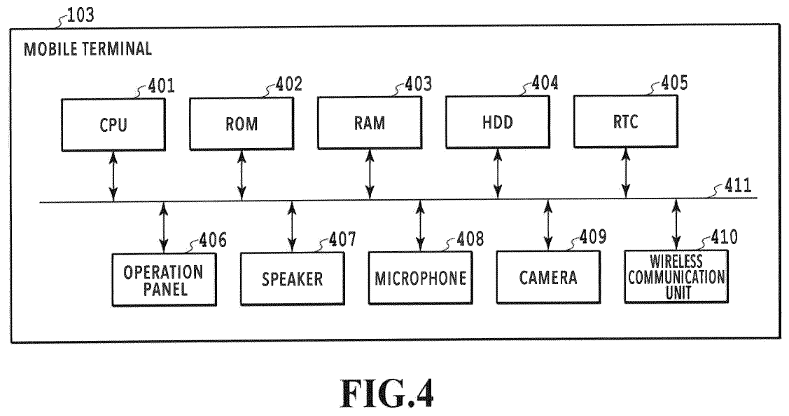

FIG. 4 is a hardware configuration diagram of the mobile terminal 103. The mobile terminal 103 includes a CPU 401, a ROM 402, a RAM 403, an HDD 404, a real time clock (RTC) 405, an operation panel 406, a speaker 407, a microphone 408, a camera 409, and a wireless communication unit 410. In the mobile terminal 103, the CPU 401 is a calculation apparatus to control the entire system. The CPU 401 comprehensively controls devices connected to a system bus 411. The ROM 402 is a non-volatile memory and stores image data, other types of data, and various programs for causing the CPU 401 to operate. The RAM 403 is a volatile memory and is used as temporary storage areas such as a main memory and a work area for the CPU 401. In the RAM 403, programs such as an operation system, system software, and application software and data are located.

The CPU 401 controls the units of the mobile terminal 103 by loading a program stored in the ROM 402 or the like to the RAM 403 and executing the program. The program for causing the CPU 401 to operate is not limited to the program stored in the ROM 402, but may be a program stored in advance in the HDD 404 or the like. The HDD 404 stores the operating system, system software, application software, photographs, electronic documents, setting data, and so on. Instead of the HDD 404, any other type of storage apparatus such as an SSD, an SD memory card or an eMMC may be used as long as it can store data. The RTC 405 measures a time.

The operation panel 406 has a touch panel function capable of detecting a touch operation by the user 101, and displays various screens provided by an OS 530 and an MFP application 502. The user 101 is enabled to input a desired operation instruction by inputting a touch operation on the operation panel 406. The speaker 407 and the microphone 408 are used by the user 101 to make a telephone call to another mobile terminal or landline phone. The camera 409 captures an image in response to an image capture instruction from the user 101. Photographs captured by the camera 409 are stored in a predetermined area in the HDD 404. The wireless communication unit 410 executes wireless communication on a wireless communication LAN or the like.

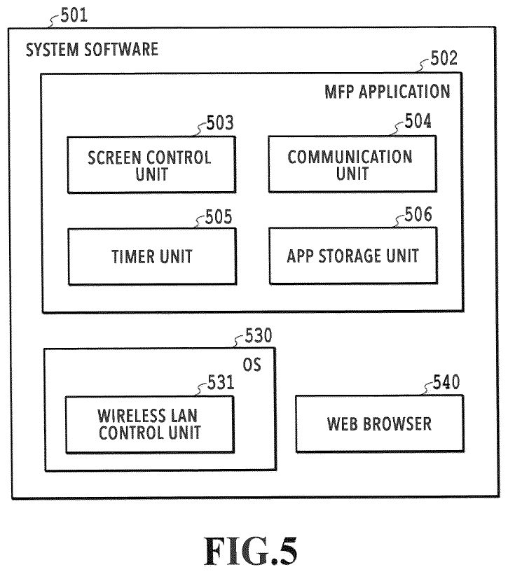

FIG. 5 is a software configuration diagram of the mobile terminal 103. System software 501 is stored in any storage unit among the RAM 403, the ROM 402, and the HDD 404, and is executed by the CPU 401. The system software 501 includes the MFP application 502, the OS 530, and a Web browser 540. The MFP application 502 includes a screen control unit 503, a communication unit 504, a timer unit 505, and an APP storage unit 506.

The OS 530 is software for controlling operations of the entire mobile terminal 103. In the mobile terminal 103, various applications including the MFP application 502 to be described later can be installed. The OS 530 exchanges information with these applications, and changes a screen displayed on the operation panel 406 according to an instruction received from an application. The OS 530 includes a group of device drivers for controlling various kinds of hardware. The OS 530 provides each of the applications running on the OS 530 with an application programming interface (API) for using the various kinds of hardware. The group of device drivers includes a wireless LAN control unit 531 in the present embodiment. The wireless LAN control unit 531 is a device driver for controlling the wireless communication unit 410. The MFP application 502 is an application installed in the mobile terminal 103. Using the MFP application 502, the user 101 can issue print and scan instructions to an image forming apparatus such as the image forming apparatus 102 and remotely operates an operation screen of the image forming apparatus.

The Web browser 540 is software for connecting to a Web server and can display a content of a Web page at a designated URL. In the mobile terminal 103, various applications other than the MFP application 502 and the Web browser 540 are installed, but their description is omitted herein.

The software configuration of the MFP application 502 will be described in more details. The screen control unit 503 controls a screen displayed on the operation panel 406 via the OS 530. The screen control unit 503 displays an MFP application screen on the operation panel 406. The screen control unit 503 also determines an operation instruction input by the user 101 via the operation panel 406. The communication unit 504 controls the wireless communication by the wireless communication unit 410 via the OS 530, and performs command transmissions and receptions and the like. The timer unit 505 measures a time. The APP storage unit 506 temporarily stores, in the RAM 403, various types of information for executing the MFP application 502.

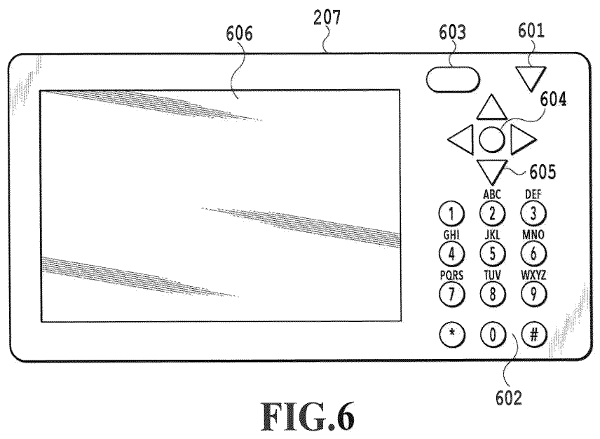

FIG. 6 is an overview of the display/operation unit 207 of the image forming apparatus 102. On the display/operation unit 207, the display 606 and the hard keys 601 to 605 are arranged next to each other. The various buttons to be operated by the user 101 will be described. The stop key 601 is used, for example, to stop an operation in progress. The numeric keypad 602 includes number and alphabet buttons, and is used, for example, to set a time point, make a password authentication, and switch the screen on the display 606. One or more characters are allocated to each key in the numeric keypad 602. For example, characters such as “2”, “A”, “B”, “C”, “a”, “b”, “c” are allocated to the key “2”. The home key 603 is used to transition a screen display on the display 606 to a home screen. The decision button 604 is used to decide an item selected on the display 606 or to press a selected button. The cross key 605 is used to move the position of a cursor or a focus on the display 606 up, down, left or right. These various buttons are just examples, and buttons not listed above may also be provided. Also, the functions of the various buttons may differ from those described above. Moreover, the various buttons do not have to be hard keys, but may be software keys displayed on the display 606.

Hereinafter, general seal removal from initial state cartridges will be further described. The image forming apparatus automatically and simultaneously remove the seals from all of initial state cartridges installed in the image forming apparatus. For example, in the case where initial state cartridges of three colors (cyan, magenta, and yellow) are installed in an image forming apparatus capable of performing color printing, the seal removal is performed simultaneously on these three cartridges. For this reason, the seal removal performed on multiple initial state cartridges requires a stronger torque than that on only one cartridge, and therefore may fail due to a torque shortage. Moreover, a toner or the like inside an initial state cartridge may clump depending on storage conditions (such as a temperature, the orientation of the placed cartridge, and the presence or absence of vibration). In the case where the toner and the seal adhere to each other due to such clumping, there is a high possibility of the seal removal failing.

In such a case, it is necessary to reduce the number of initial state cartridges in the seal removal operation, thereby reducing the torque required and avoiding the torque shortage to enable the seals to be removed successfully. However, there is a problem in that a user does not know a proper procedure to achieve this.

In view of the aforementioned problem, in the present embodiment, in response to a detection of a failure of the seal removal from initial state cartridges by the image forming apparatus, the image forming apparatus is controlled to notify the user of information on which cartridge needs to be uninstalled to enable the seals to be successfully removed. The detail thereof will be described below.

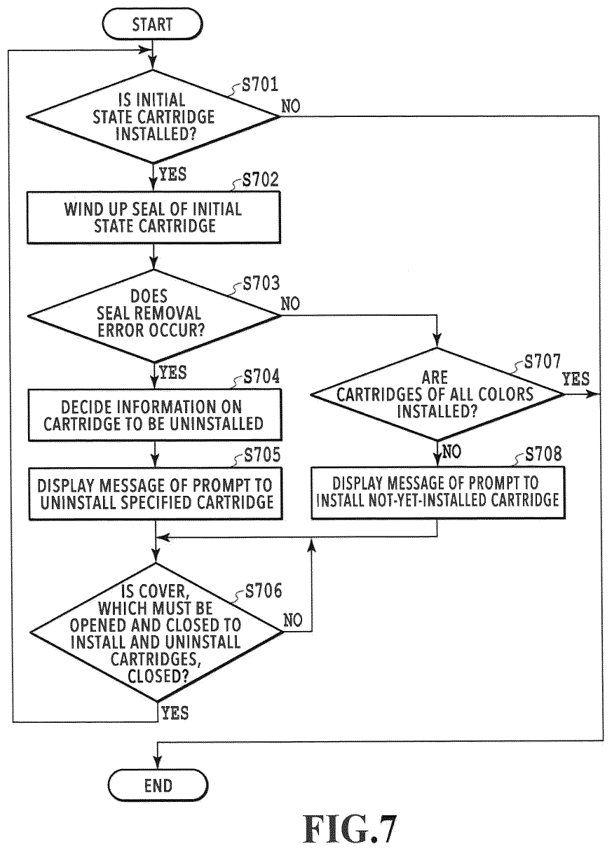

FIG. 7 is a flowchart of processing in which the CPU 202 of the image forming apparatus 102 notifies the user 101 of a proper procedure for a success in seal removal in the case where the image forming apparatus 102 fails the seal removal from initial state cartridges (a seal removal error occurs). The present processing is executed by the CPU 202 of the image forming apparatus 102 loading a program stored in the ROM 204 or the like to the RAM 203. The present processing is started upon powering-on, returning from a power saving status, and detecting that a cover, which must be opened and closed for installing and uninstalling cartridges, is closed.

In S701, the CPU 202 determines whether initial state cartridges are installed in the image forming apparatus 102. Specifically, the CPU 202 determines that the initial state cartridges are installed in the case where information indicating that the initial state cartridges are installed is received from the printer 213 or determines that the initial state cartridges are not installed in the case where the information indicating that the initial state cartridges are installed is not received from the printer 213. The printer 213 determines that the initial state cartridges are installed in the image forming apparatus 102 in the case where brand-new flag information is stored in memory tags of the installed cartridges, or determines that the initial state cartridges are not installed in the image forming apparatus 102 in the case where the brand-new flag information is not stored in the memory tags of the installed cartridges. The method of determining whether initial state cartridges are installed is not particularly limited. For example, the printer 213 may determine that initial state cartridges are installed in the image forming apparatus 102 in the case where a sensor equipped in the detection unit 210 detects that the seals are attached to the cartridges and determine that the initial state cartridges are not installed in the image forming apparatus 102 in the case where the sensor equipped in the detection unit 210 does not detect that the seals are attached to the cartridges. If determining in S701 that the initial state cartridges are not installed in the image forming apparatus 102, the CPU 202 ends the processing of the present flowchart. On the other hand, if determining in S701 that the initial state cartridges are installed in the image forming apparatus 102, the CPU 202 proceeds to S702.

In S702, the CPU 202 uses the removal unit 211 to wind up the seals attached to the openings of all the initial state cartridges installed in the image forming apparatus 102. The winding is performed simultaneously on all the initial state cartridges by using the same rotation shaft. In short, the seal removal is performed in a single winding operation.

In S703, the CPU 202 determines whether a seal removal error (seal winding error) of the cartridges occurs. In other words, the CPU 202 determines whether the seal removal from the cartridges fails. Specifically, the CPU 202 determines that the seal removal error occurs in the case where the CPU 202 receives an event from the printer 213 notifying the CPU 202 of the occurrence of the seal removal error and determines that the seal removal error does not occur in the case where the CPU 202 does not receive the event. Here, the printer 213 to transmit the above event determines that the seal removal fails in the case where the number of rotations of the rotation shaft of the removal unit 211 for executing the seal removal does not reach a prescribed value (or a value within a prescribed range) or where the rotation speed during steady rotation deviates from a prescribed value (or a value within a prescribed range), and determines that the seal removal succeeds in the case where the number of rotations of the rotation shaft reaches the prescribed value (or a value within the prescribed range). The method of determining whether a seal removal error occurs is not particularly limited. For example, the printer 213 may determine that the seal removal fails in the case where the sensor equipped in the detection unit 210 detects that the seals are attached to the cartridges and determine that the seal removal does not fail (succeeds) in the case where the sensor equipped in the detection unit 210 does not detect that the seals are attached to the cartridges. The CPU 202 proceeds to S704 if determining that the cartridge seal removal error occurs. On the other hand, the CPU 202 proceeds to S707 if determining that the cartridge seal removal error does not occur.

In S704, the CPU 202 decides specifying information (color and number) that specifies which initial state cartridge should be uninstalled in order to successfully wind up the seals, and proceeds to S705. The reason for deciding an initial state cartridge to be uninstalled in the present processing is to avoid a torque shortage by temporarily reducing the number of initial state cartridges, thereby improving the possibility of succeeding in seal winding. In the present embodiment, the example is described in which the CPU 202 receives the specifying information from the printer 213, but a unit to decide the specifying information may be another unit, like a case where, for example, the controller unit 201 decides the specifying information based on a predetermined priority order. Also, in the present embodiment, a control example is described in which the number in this specifying information is always “1” regardless of the number of installed initial state cartridges, but the number may be two or more. The case where the number in the specifying information is two or more will be described later. The “color” in the specifying information is any of the colors of the initial state cartridges installed in the image forming apparatus 102.

In S705, the CPU 202 displays, on the display 606 of the image forming apparatus 102, information that the specified initial state cartridge is to be uninstalled based on the specifying information decided in S704. Specifically, a message of a prompt to uninstall the specified initial state cartridge (a seal removal error screen to be described later) or a message of a prompt to uninstall the specified initial state cartridge and close a cover of a holder unit for holding the cartridges is displayed on the display 606 of the image forming apparatus 102. As a result, in a state where the specified initial state cartridge based on the specifying information decided in S704 is not installed in the image forming apparatus 102, the seals attached to the initial state cartridges installed in the image forming apparatus 102 can be wound up by using the removal unit 211. This makes it possible to reduce the number of initial state cartridges in the seal winding operation, increasing the possibility of avoiding the torque shortage and improving the possibility of succeeding in the seal winding. In the present embodiment, the example is described in which the message is displayed on the display 606, but the method of notifying the user 101 is not limited to this. For example, a notification may be made by another unit, like a notification made with lighting of an LED lamp provided in the image forming apparatus 102, a notification made via the MFP application 502 installed in an external terminal such as the mobile terminal 103 (for example, a notification displayed on the display unit of the external terminal), or any other notification.

In S706, the CPU 202 determines whether the cover, which must be opened and closed for installing and uninstalling the cartridges (the cover of the holder unit for the cartridges), is closed. The CPU 202 returns to S701 if determining that the cover is closed. On the other hand, the CPU 202 returns to S706 if determining that the cover is not closed. In the present embodiment, the CPU 202 determines that the cover is closed when the CPU 202 stops receiving an event making a notification that the cover is opened from the printer 213 after receiving the event. However, the determination method may be another method. For example, the CPU 202 may be configured to receive an event making a notification that the cover is closed and determine that the cover is closed when the CPU 202 receives the event making the notification that the cover is closed.

In S707, the CPU 202 determines whether the cartridges of all the colors are installed in the image forming apparatus 102. If determining that the cartridges of all the colors are installed, the CPU 202 ends the processing of the present flowchart. On the other hand, if determining that the cartridge of any color is not installed, the CPU 202 proceeds to S708. The process in S707 is a process to which the CPU 202 also proceeds, for example, if the seal removal succeeds as a result of uninstalling the initial state cartridge and performing the seal removal again after the occurrence of the seal removal error in S703. In other words, at the stage where the CPU 202 proceeds to S707, there may be a case where the uninstalled initial state cartridge exists. For this reason, the process in S707 is to determine whether the initial state cartridge once uninstalled (not-yet-installed cartridge) exists. In the present embodiment, the CPU 202 determines that the cartridges of all the colors are installed in the image forming apparatus 102 in the case where the CPU 202 does not receive any one event making a notification that a cartridge is not yet installed from the printer 213. The CPU 202 determines that the cartridge of any color is not yet installed in the image forming apparatus 102 in the case where the CPU 202 receives even one event described above. However, the determination method may be another method.

In S708, the CPU 202 displays a message of a prompt to install the cartridge of the color not yet installed on the display 606 of image forming apparatus 102.

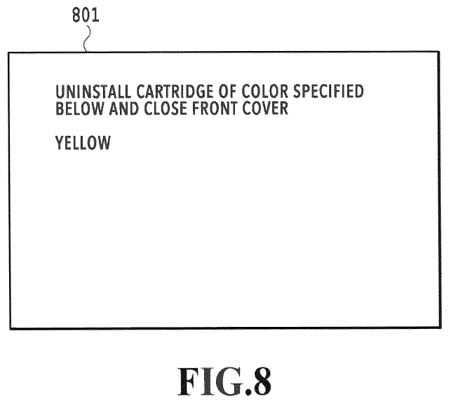

FIG. 8 is a diagram illustrating a seal removal error screen in the present embodiment. In the present embodiment, a seal removal error screen 801 as illustrated in FIG. 8 is displayed on the display 606 of the image forming apparatus 102 in the case where a seal removal error occurs in a state where multiple initial state cartridges including a yellow cartridge are installed in the image forming apparatus 102. The seal removal error screen 801 is an error screen displayed in S705 in the case where the color “yellow” and the number “1” are decided as the specifying information on the cartridge to be uninstalled in S704. FIG. 8 is a diagram illustrating an example of making a notification of a type of initial state cartridge to be uninstalled so that only one initial state cartridge remains installed, regardless of the number of the initial state cartridges installed.

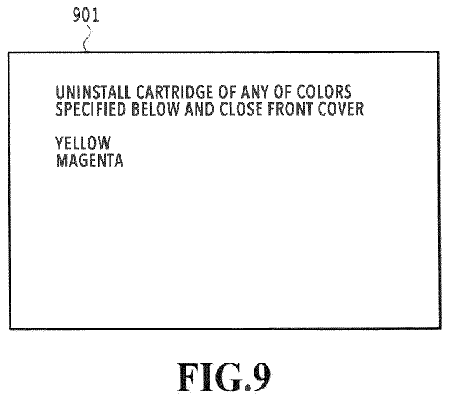

FIG. 9 is a diagram illustrating a seal removal error screen in the present embodiment as in FIG. 8. A seal removal error screen 901 illustrated in FIG. 9 is a screen displayed in the case where the colors “yellow” and “magenta” and the number “1” are decided as the specifying information on the cartridge to be uninstalled in S704. The seal removal error screen 901 illustrated in FIG. 9 indicates that the user may select and uninstall any one of the yellow and magenta initial state cartridges. In other words, FIG. 9 is a diagram indicating that, under the condition that only one initial state cartridge remains installed, the user may select and uninstall any initial state cartridges as many as the number of initial state cartridges to be uninstalled.

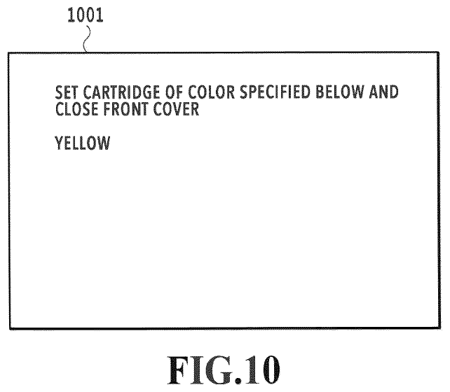

FIG. 10 is a diagram illustrating a cartridge non-installation error screen in the present embodiment. In the case where only the yellow cartridge is not yet installed in the image forming apparatus 102 in S707 in FIG. 7, a cartridge non-installation error screen 1001 in FIG. 10 is displayed in S708. Here, in the case where multiple cartridges are not yet installed, a list of all of their colors is displayed like “YELLOW” illustrated in FIG. 10.

The seal removal error screens in FIGS. 8 and 9 and the cartridge non-installation error screen in FIG. 10 are just examples. The image forming apparatus 102 may actually display other screens. Hereinafter, using FIGS. 8 to 10, how the user 101 solves the seal removal error in the present embodiment will be described based on the flowchart in FIG. 7 together with a user's action example.

For example, in the case where the seal removal error occurs in S703 in a state where two initial state cartridges, yellow and magenta cartridges, are installed in the image forming apparatus 102, the seal removal error screen 801 or 901 is displayed on the display 606 in S705. Here, which of the seal removal error screens 801 and 901 is to be displayed may be decided in advance according to a user's setting operation. Viewing the seal removal error screen 801 or 901, the user 101 uninstalls the yellow cartridge and closes a front cover. As a result, YES is determined in S706 and the processing proceeds to S701. Since only one initial state cartridge (magenta) is installed in the image forming apparatus 102 in S701, the processing proceeds to S702. In S702, the seal winding of the initial state cartridge is performed again in the state where the number of initial state cartridges is reduced by one (the yellow cartridge is uninstalled and only one cartridge, the magenta cartridge remains). Since the number of the initial state cartridges installed in the image forming apparatus 102 is reduced from 2 to 1, the torque required to wind up the seals attached to the openings of the initial state cartridges is also reduced, which results in avoidance of a torque shortage. In other words, the possibility of succeeding in the seal winding is improved.

After it is determined in S703 that the seal winding of the magenta initial state cartridge succeeds, the processing proceeds to S708 because the yellow cartridge remains uninstalled in S707. Thus, the cartridge non-installation error screen 1001 is displayed on the display 606 in S708. In this process, the cartridge non-installation error screen 1001 displays only one color, yellow. Viewing this screen, the user 101 reinstalls the previously-uninstalled yellow initial state cartridge, and closes the front cover of the image forming apparatus 102. As a result, YES is determined in in S706. Since the one initial state cartridge (yellow) is installed in S701, the processing proceeds to S702. In S702, the seal winding of the initial state cartridge is performed again in the state where the number of initial state cartridges is reduced by one (only one cartridge, the yellow cartridge exists). Naturally, no torque shortage occurs in the seal winding at this time either, and the seal winding of the yellow initial state cartridge succeeds (NO is determined in S703). According to the above sequence, the user 101 can solve the seal removal error in the state where the cartridges of all the colors are installed (YES is determined in S707). In addition, the user's action is just to uninstall and install the initial state cartridge while checking the display and is easy to carry out.

As described above, according to the present embodiment, it is possible to make a notification of the procedure of reliably removing the seal members of the initial state cartridges. Specifically, in the case where the seal removal of the initial state cartridges fails, the colors and number of the initial state cartridges to be uninstalled is displayed on the display 606. Thus, the user can uninstall the initial state cartridge while checking the displayed content, and if the second seal removal succeeds, reinstall the uninstalled initial state cartridge while also checking the displayed content. In short, checking the displayed contents, the user can easily and properly uninstall the initial state cartridge to be uninstalled.

### Embodiment 2

In Embodiment 1, in the case where a seal removal error occurs in the image forming apparatus 102, the image forming apparatus 102 is controlled such that the number in the specifying information on which cartridge should be uninstalled to successfully remove the seals is always one. Therefore, the user 101 is always notified of one cartridge on the seal removal error screen 801 or 901. On the other hand, in Embodiment 2, the image forming apparatus 102 is controlled such that the number in the specifying information decided in the case where a seal removal error occurs is one or more. The number in the specifying information may be decided in a method of, for example, subtracting one from the number of the initial state cartridges currently installed in the image forming apparatus 102, but other decision methods may be used. Here, the number in the specifying information is less than the number of initial state cartridges currently installed in the image forming apparatus 102. A flowchart of the image forming apparatus 102 in Embodiment 2 will be described by using FIG. 7 as is the case with Embodiment 1.

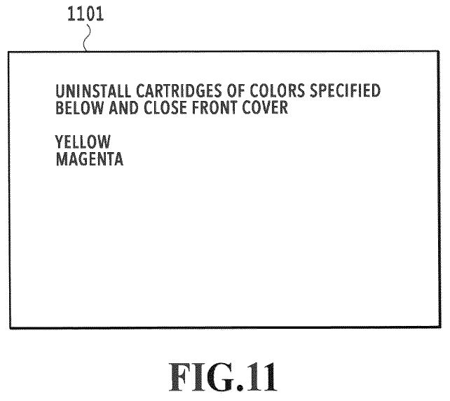

FIG. 11 is a diagram illustrating a seal removal error screen in the present embodiment. This diagram is displayed on the display 606 of the image forming apparatus 102 in the case where a seal removal error occurs in a state where three or more initial state cartridges including yellow and magenta cartridges are installed in the image forming apparatus 102. A seal removal error screen 1101 is an error screen displayed in S705 in the case where the colors “yellow” and “magenta” and the number “2” are decided as the specifying information on the cartridges to be uninstalled in S704.

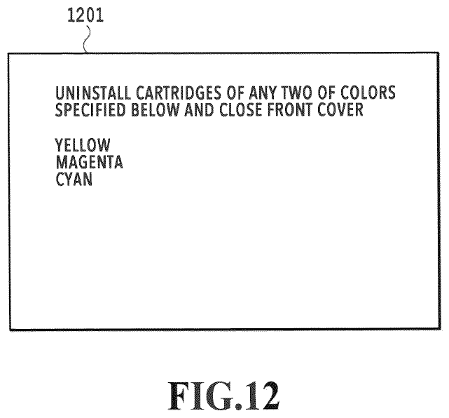

FIG. 12 is a diagram illustrating a seal removal error screen in the present embodiment as in FIG. 11. In the case where the colors “yellow”, “magenta”, and “cyan” and the number “2” are decided as the specifying information on the cartridges to be uninstalled in S704, a seal removal error screen 1201 illustrated in FIG. 12 may be displayed instead of the seal removal error screen 1101. The seal removal error screen 1201 illustrated in FIG. 12 indicates that the user may select and uninstall any two of the yellow, magenta, and cyan initial state cartridges. In this way, the user may select as many cartridges as the number of cartridges to be uninstalled. Hereinafter, using FIGS. 10 to 12, how the user 101 solves a seal removal error in the present embodiment will be described based on the flowchart in FIG. 7 together with a user's action example.

For example, in the case where a seal removal error occurs in S703 in a state where three initial state cartridges, yellow, magenta, and cyan cartridges, are installed, the seal removal error screen 1101 or 1201 is displayed in S705. Here, which of the seal removal error screens 1101 and 1201 is to be displayed may be decided in advance according to a user's setting operation. Viewing the seal removal error screen 1101 or 1201, the user 101 uninstalls the two cartridges, the yellow and magenta cartridges, and closes the front cover. As a result, YES is determined in S706 and the processing proceeds to S701. Since the one initial state cartridge (cyan) is installed in S701, the processing proceeds to S702. In S702, the seal winding of the initial state cartridge is performed again in the state where the number of initial state cartridges is reduced by two (the yellow and magenta cartridges are uninstalled and only one cartridge, the cyan cartridge remains). Since the number of the initial state cartridges installed in the image forming apparatus 102 is reduced from 3 to 1, the torque required to wind up the seals attached to the openings of the initial state cartridges is also reduced, which results in avoidance of a torque shortage. In other words, the possibility of succeeding in the seal winding is improved. After it is determined in S703 that the seal winding of the cyan initial state cartridge succeeds, the processing proceeds to S708 because the yellow and magenta cartridges remain uninstalled in S707. In S708, the cartridge noninstallation error screen 1001 is displayed on the display 606. In this process, the cartridge non-installation error screen 1001 displays two colors, yellow and magenta. Viewing this screen, the user 101 reinstalls the previously-uninstalled yellow and magenta initial state cartridges, and closes the front cover of the image forming apparatus 102. As a result, YES is determined in S706. Since the two initial state cartridges (yellow and magenta) are installed in S701, the processing proceeds to S702. In the case where it is determined that the seal winding of these two initial state cartridges succeeds in S702 (NO in S703), the processing proceeds to S707. In S707, it is determined that the cartridges of all the colors are installed, and therefore the processing ends.

On the other hand, in the case where it is determined in S703 that the seal winding of the two initial state cartridges, the yellow and magenta cartridges, fails, the processing proceeds to S704. The following sequence is the same as in the procedure of solving the seal removal error described by using FIGS. 7 to 10 in Embodiment 1. Specifically, the processing of uninstalling one initial state cartridge and performing the seal winding is repeated.

According to the foregoing method, the user 101 is enabled to make the seal removal succeed by taking the proper procedure even in the case where two or more initial state cartridges are to be uninstalled.

### Other Embodiments

In foregoing Embodiments 1 and 2, the examples are described in which, in the case where a seal removal error occurs, a notification of an instruction to uninstall the initial state cartridges so that only one initial state cartridge may remain is made on the display 606. However, an embodiment is not limited to this. For example, an embodiment may be employed in which, in the case where a seal removal error occurs, a notification is made to provide information that the initial state cartridges are to be reduced one by one. Instead, an embodiment may be employed in which a notification is made to provide information that the number of installed initial state cartridges is to be reduced to half or less. In addition, an embodiment may be employed in which in the case where the seal removal succeeds in the state where only one initial state cartridge remains, the previously-uninstalled initial cartridges are not all returned once but are returned one by one and the seal winding is performed every time one cartridge is returned, and a notification of information instructing this way may be made.

In the foregoing embodiments, there may be a case where the seal winding fails even in the state where there is only one initial state cartridge. In such a case, a cause for the seal removal error is considered to be adhesion of the toner to the seal. As an error screen in the case where only one initial state cartridge is installed, a notification may be made to give an instruction to uninstall the initial state cartridge, fully shake the cartridge, and then reinstall the cartridge.

According to the present disclosure, it is possible to improve usability in an initial state setting of an image forming apparatus.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-167604, filed Sep. 26, 2024, which is hereby incorporated by reference herein in its entirety.

What is claimed is:

1. An image forming apparatus on which an initial state cartridge, which is a cartridge with a seal member attached, is installable, the image forming apparatus comprising at least one memory and at least one processor, and/or at least one circuit which function as:
a removal unit configured to perform an operation of removing one or more seal members of one or more initial state cartridges installed, and
a notification unit configured to, in a case where the removal unit fails to remove the one or more seal members, make a notification of information that at least one of the installed initial state cartridges is to be uninstalled from the image forming apparatus.

2. The image forming apparatus according to claim 1, wherein in the case where the removal unit fails to remove the one or more seal members, the notification unit makes a notification of information that at least one of the installed initial state cartridges is to be uninstalled from the image forming apparatus and that a cover of a holder unit configured to hold the cartridges is to be closed.

3. The image forming apparatus according to claim 2, wherein in a case where the cover of the holder unit is closed in the image forming apparatus after the notification unit makes the notification, the removal unit performs a second removal operation of again removing the one or more seal members of the one or more initial state cartridges installed.

4. The image forming apparatus according to claim 3, wherein in a case where the removal unit succeeds in removing the one or more seal members as a result of performing the second removal operation and where there is a not-yet-installed cartridge, which is a cartridge to be installed in the image forming apparatus, the notification unit makes a notification of an instruction to install the not-yet-installed cartridge.

5. The image forming apparatus according to claim 4, wherein the notification unit makes a notification of one or more types of the initial state cartridges to be uninstalled so that only one of the initial state cartridges remains installed.

6. The image forming apparatus according to claim 4, wherein the notification unit makes a notification of an instruction to uninstall a predetermined number of initial state cartridges.

7. The image forming apparatus according to claim 4, wherein in a case where the removal unit succeeds in removing the one or more seal members of all of the one or more initial state cartridges installed as a result of performing the second removal operation, the notification unit makes a notification of an instruction to install all of not yet-installed cartridges.

8. The image forming apparatus according to claim 7, wherein in a case where the removal unit performs a third removal operation of again removing the one or more seal members of the one or more initial state cartridges installed in a state where all of the not yet-installed cartridges are installed and fails to remove the one or more seal members of all of the one or more initial state cartridges installed, the notification unit again makes a notification of an instruction to uninstall any of the initial state cartridges.

9. The image forming apparatus according to claim 4, wherein in a case where the removal unit succeeds in removing the one or more seal members of all of the one or more initial state cartridges installed as a result of performing the second removal operation, the notification unit makes a notification of an instruction to install one of the not-yet-installed cartridges.

10. The image forming apparatus according to claim 9, wherein in a case where the removal unit performs a third removal operation of removing the one or more seal members of the one or more initial state cartridges installed in a state where one of the not-yet-installed cartridges is installed and succeeds in removing the one or more seal members of the one or more initial state cartridges installed, the notification unit makes a notification of an instruction to further install one of the not-yet-installed cartridges.

11. The image forming apparatus according to claim 1, wherein in the case where the removal unit fails to remove the one or more seal members, the notification unit makes a notification of information that at least one of the installed initial state cartridges is to be uninstalled from the image forming apparatus by displaying the information on a display unit included in the image forming apparatus.

12. The image forming apparatus according to claim 1, wherein in the case where the removal unit fails to remove the one or more seal members, the notification unit makes a notification of information that at least one of the installed initial state cartridges is to be uninstalled from the image forming apparatus by lighting an LED lamp included in the image forming apparatus.

13. The image forming apparatus according to claim 1, wherein in the case where the removal unit fails to remove the one or more seal members, the notification unit makes, via an application installed in an external terminal, a notification of information that at least one of the installed initial state cartridges is to be uninstalled from the image forming apparatus.

14. The image forming apparatus according to claim 1, wherein types of the initial state cartridges include yellow, magenta, cyan, and black.

15. The image forming apparatus according to claim 1, wherein in a case where the removal unit fails to remove the seal member in a state where one initial state cartridge is installed in the image forming apparatus, the notification unit makes a notification that the installed initial state cartridge is to be uninstalled from the image forming apparatus, be shaken, and then be reinstalled.

16. A method of controlling an image forming apparatus on which an initial state cartridge, which is a cartridge with a seal member attached, is installable, the method comprising:
a removal step of removing one or more seal members of one or more initial state cartridges installed; and
a notification step of, in a case where the one or more seal members fail to be removed in the removal step, making a notification of information that at least one of the installed initial state cartridges is to be uninstalled from the image forming apparatus.

17. A non-transitory computer readable storage medium storing a program which functions in an image forming apparatus on which an initial state cartridge, which is a cartridge with a seal member attached, is installable, the program causing the image forming apparatus to function as:
a removal unit configured to perform an operation of removing one or more seal members of one or more initial state cartridges installed, and
a notification unit configured to, in a case where the removal unit fails to remove the one or more seal members, make a notification of information that at least one of the installed initial state cartridges is to be uninstalled from the image forming apparatus.
